(19) United States
(12) Patent Application Publication
(10) Pub. No.: US 2026/0249446 A1
(43) Pub. Date: Aug. 27, 2026

(54) Ambidextrous Delta Robot with Vertical Backplane

(71) Applicant: Zoho Corporation Private Limited, Kanchipuram District (IN)

(72) Inventor: Leonard Maurice Ginsburg, Berkeley, CA (US)

(21) Appl. No.: 19/089,321

(22) Filed: Mar. 25, 2025

Related U.S. Application Data
(60) Provisional application No. 63/761,373, filed on Feb. 21, 2025.

(51) Int. Cl. B25J 9/10; B25J 9/00; B25J 17/00

(52) U.S. Cl. CPC B25J 9/106; B25J 9/0009; B25J 17/00

(57) ABSTRACT

An ambidextrous robot has symmetrical sets of arms mounted to a vertical backplane. Each set of arms manipulates a respective end effector. The arms in each set are unevenly spaced so that the two sets can be positioned close together without interference. The backplane can be separated into independently movable sections to allow the end effectors additional freedom of movement.

### CROSS REFERENCE TO RELATED APPLICATION

This application claims priority from U.S. Provisional Application Ser. No. 63/761,373 filed 21 Feb. 2025 entitled “Ambidextrous Delta Robot with Vertical Backplane” by Leonard Maurice Ginsburg, which is incorporated herein by reference.

### FIELD OF THE INVENTION

The subject matter presented herein relates generally to robots.

### BACKGROUND

A delta robot includes three or four arms suspended from a common base. Each arm includes a proximal link connected to the base and a distal link connected to an “end effector” that can be or include a tool. The arms are actuated by motors (actuators) mounted to the base, which drive the arms to move the end effector in a coordinated manner, allowing for precise movement in three-dimensional space. Heavy elements, like actuators and control systems, are mounted to the base. Links, joints, and end effectors can be lightweight, so delta robots can perform rapid, repetitive tasks with minimal inertia. This property makes delta robots an excellent choice for packaging, manufacturing, and assembly lines where speed and precision are paramount. The design also allows for easy maintenance and can be adapted with various end-effectors to suit different operational needs, making delta robots highly versatile in industrial settings.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 depicts a robot 100 in which symmetrical sets of three arms mounted to a vertical backplane 105 manipulate respective end effectors 110A and 110B.

FIG. 2 includes top and front views of robot 100 in an embodiment in which independently articulable backplanes 105A and 105B are mounted to a support 200 via respective hinges 205A and 205B.

FIG. 3 depicts a robot 300 in accordance with an embodiment in which robot 100 of FIG. 1 is mounted on a frame 305 that also supports a housing 310 with control circuitry 315 and a suite of sensors 320 for managing actuators 115 to control end effectors 110A and 110B and any tools that might be attached thereto.

FIG. 4 is an oblique side view of robot 300 of FIG. 3 showing that frame 305 extends behind and supports vertical backplanes 105A and 105B.

FIG. 5 is an oblique rear view of robot 300 of FIG. 3 with a housing 500 covering the back of robot 300.

FIG. 6 depicts an autonomous or remote-controlled fruit-harvesting system 600 in which robot 100 of FIG. 1 is mounted on a slide 605 that moves up and down a guide rail 610 pivotally attached to a motorized, wheeled base 615.

FIG. 7 is a front view of a split-backplane robot 700 in accordance with another embodiment.

FIG. 8 is a back view of split-backplane robot 700 of FIG. 7 showing hinge support 705 and hinges 720 in more detail.

### DETAILED DESCRIPTION

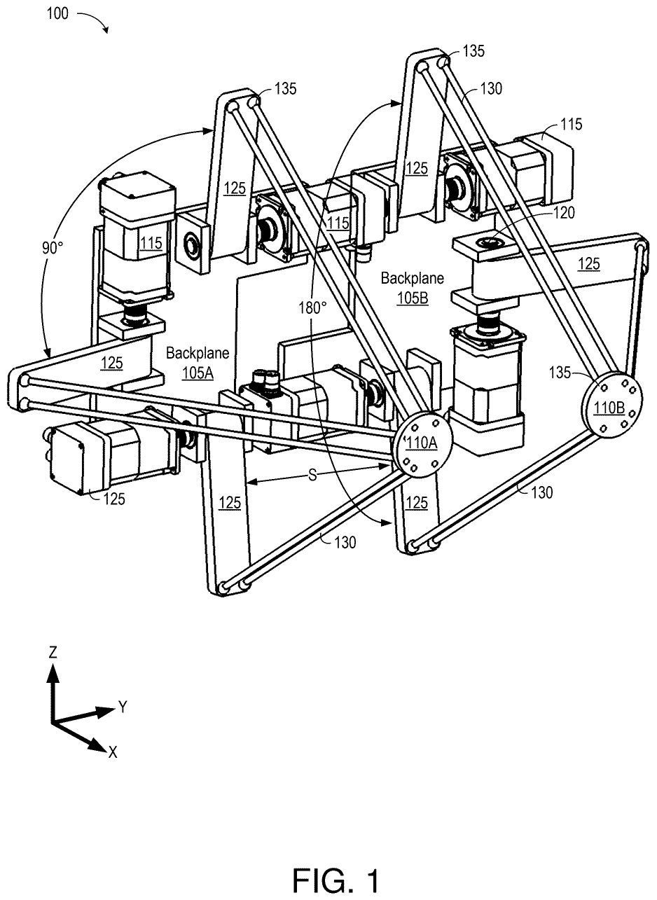

FIG. 1 depicts a robot 100 in which symmetrical sets of three arms mounted to a vertical backplane 105 manipulate respective end effectors 110A and 110B. Robot 100 is ambidextrous, which is to say it can control and position both end effectors 110A and 110B with equal skill and proficiency. Each of six actuators (e.g. stepper motors) 115 mounted to backplane 105 defines an axis of rotation 120. Six identical arms, one extending from each actuator 115, include a proximal link 125 connected to the actuator and a distal link 130 connected to the proximal link via a rotary joint 135. In this example, each distal link 130 includes parallel links with rotary joints at both ends.

Backplane 105 is separated into independently movable backplanes 105A and 105B. Considering backplane 105A first, an opposing pair of proximal links 125 extend vertically and pivot in a vertical plane orthogonal to the backplane and are thus separated by an angle of 180 degrees in the plane of the backplane. The third proximal link 125 from backplane 105A pivots in a second plane perpendicular to the plane of the other two and is thus separated by an angle of 90 degrees from each of the other proximal links 125 in the plane of the backplane. The arms associated with backplane 105B are similarly unevenly spaced but with mirror symmetry with respect to those of backplane 105A so the pairs of vertically disposed proximal links 125 can be closely spaced. In this example, the spacing S between the centers of backplanes 105A and 105B is sufficient to admit an actuator 115 but less than the length of a proximal link 125, and much less than twice the length of a proximal link 125. In another scenario the spacing S may be less than twice the length of any of proximal links 125. Some embodiments may have proximal links of different lengths attached to one or both backplanes 105A and 105B, in which case spacing S can be less than the sum of the lengths of a shortest proximal link on each of backplanes 105A and 105B.

Uneven angular spacings other than 180 and 90 degrees can be used in other embodiments, and the arrangements of the two delta robots need not have the depicted bilateral symmetry. The terms “vertical” and “horizontal” are used loosely to distinguish directions and planes that extend primarily in the vertical direction from those that extend primarily in the horizontal direction.

Robot 100 includes two delta robots mounted side-by-side on respective vertical backplanes 105A and 105B to end effectors 110A and 110B extend horizontally away from their backplanes. The uneven arm spacing allows the two delta robots to be more closely spaced. End effectors 110A and 110B can be operated together or independently to perform many tasks that might otherwise be performed by manual labor. End effectors 110A and 110B can have wrist joints (not shown) with multiple axes of motion to adapt to many different tasks.

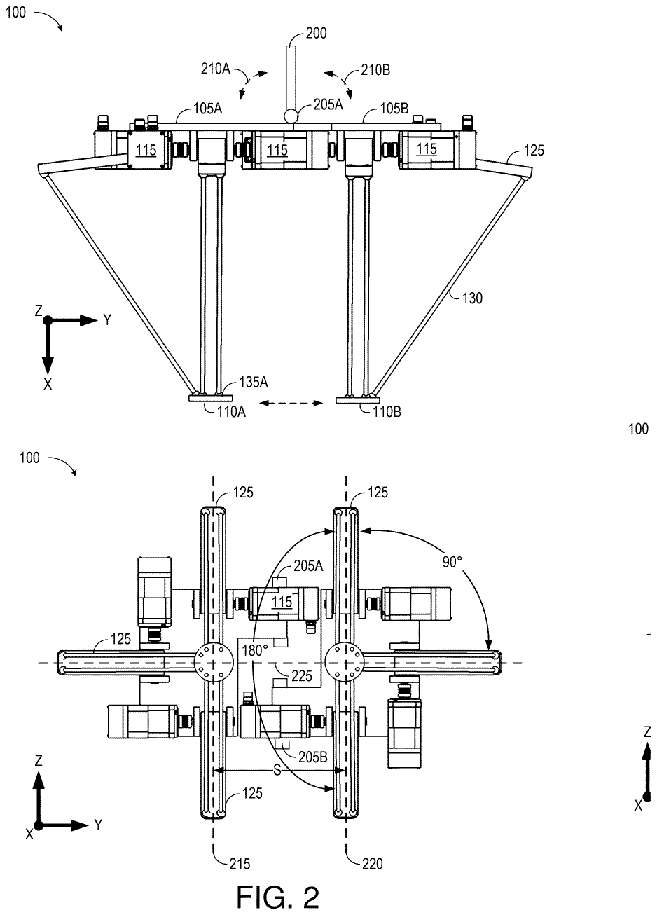

FIG. 2 includes top and front views of robot 100 in an embodiment in which independently articulable backplanes 105A and 105B are mounted to a support 200 via respective hinges 205A and 205B. Actuators (not shown) pivot backplanes 105A and 105B to change angles 210A and 210B, and thus the separation between end effectors 110A and 110B. With reference to the lower illustration, a first pair of proximal links 125 pivots in a first plane 215 in the XZ dimension that is orthogonal to backplane 105 in the ZY dimension; a second pair of the proximal links 125 pivots in a second plane 220 parallel to first plane 215, and a third pair of proximal links 125 pivots in a third plane 225 orthogonal to first and second planes 215 and 220. Planes defined by the movement of distal links 125 on each backplane intersect at backplane centers that are separated from one another by a spacing S.

Each of the two delta robots has three angularly spaced distal links 130 connected directly to one of end effectors 110A and 11B. The angular spacings between adjacent ones of distal links 130, a total of three inter-link angular spacings in this example, differ for different pairs of distal links 130. One of the three inter-link angular spacings, the 180-degree spacing in this embodiment, is twice the other two. This arrangement supports close spacings of end effectors 110A and 110B. The arms of the delta robots can be different in number and spacings in other embodiments, the largest interior angle being between 150 and 180 degrees in some embodiments.

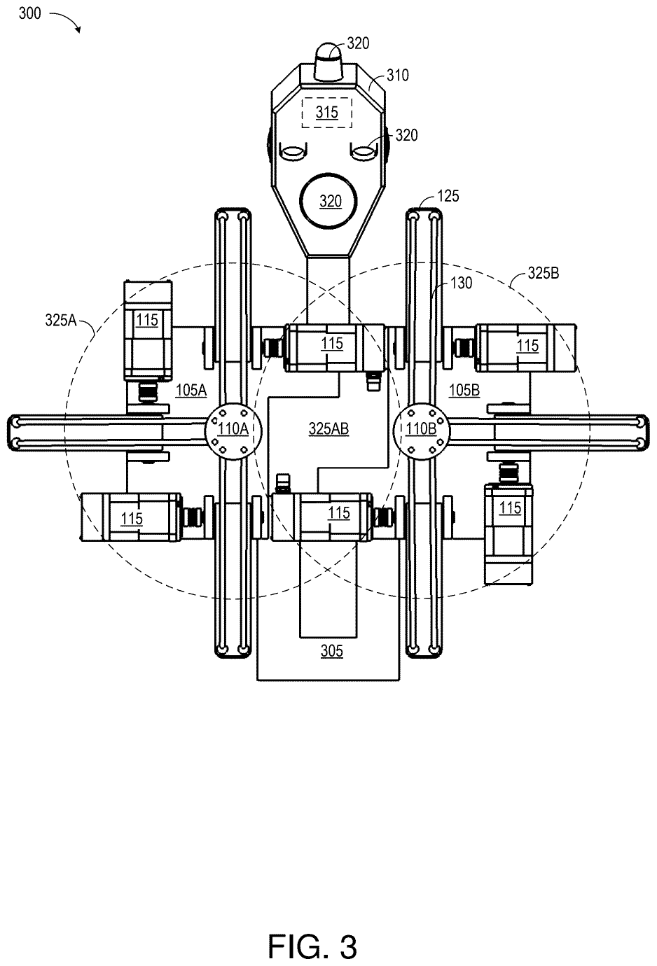

FIG. 3 depicts a robot 300 in accordance with an embodiment in which robot 100 of FIG. 1 is mounted on a frame 305 that also supports a housing 310 with control circuitry 315 and a suite of sensor 320 for managing actuators 115 to control end effectors 110A and 110B and any tools that might be attached thereto. Actuators 115 can include rotary encoders that provide precise feedback on their angular positions. Housing 310 can include one or more vision or lidar systems that provide position information for end effectors 110A and 110B, tools they support, and workpieces robot 300 is to manipulate. For example, a vision system relying on natural light could select fruit for harvesting and direct one or both end effectors 110A and 110B to move as needed to pick and store that fruit.

End effectors 110A and 110B cover respective and overlapping three-dimensional ranges of motion 325A and 325B, the extents of which are illustrated using dashed borders. Control circuitry 315 manages end effectors 110A and 110B collectively when they are used together (e.g., to simultaneously grab and cut a piece of fruit). Control circuitry 315 also manages end effectors 110A and 110B collectively when they are attending separate tasks, such as targeting different workpieces (e.g. picking different pieces of fruit) to avoid collisions.

End effectors 110A and 110B have the same sizes of links and ranges of motion in this embodiment. Ranges of motion 325A and 325B are the same in this example, but sets of arms associated with end effectors 110A and 110B can be different and optimized for different tasks or types of task, similar to heterochely in crabs. In general, range of motion decreases and speed increases with the length ratio of proximal links 125 to distal links 130. These ratios and related actuators and control circuitry can be separately optimized for each end effector. In each case of overlapping ranges of motion, control circuit 315 is connected to and manages all six actuators 115 to position the first and second end effectors 110A and 110B relative to one another as needed to avoid collisions.

The control of delta robots involves solving inverse kinematics to determine the joint angles required for specific end-effector positions. Control circuit 315 can include Proportional-Integral-Derivative (PID) controllers that adjust the motor inputs to minimize error between the desired and actual positions. Control circuit 315 can also be or include microcontrollers or personal computers that run software that interprets the control commands, performs the necessary calculations (like inverse kinematics), and sends the appropriate signals to the motor drivers. Delta robot 300 employs inverse kinematics that differ from equations used by delta robots with equally spaced arms to account for both the unequal spacings of arms and the mirror symmetry of the collections of arms. The derivations of suitable kinematic equations for desired ranges of fields, speed, torque, and link placements and lengths are well within the ability of those of skill in the art, so a detailed discussion is omitted for brevity.

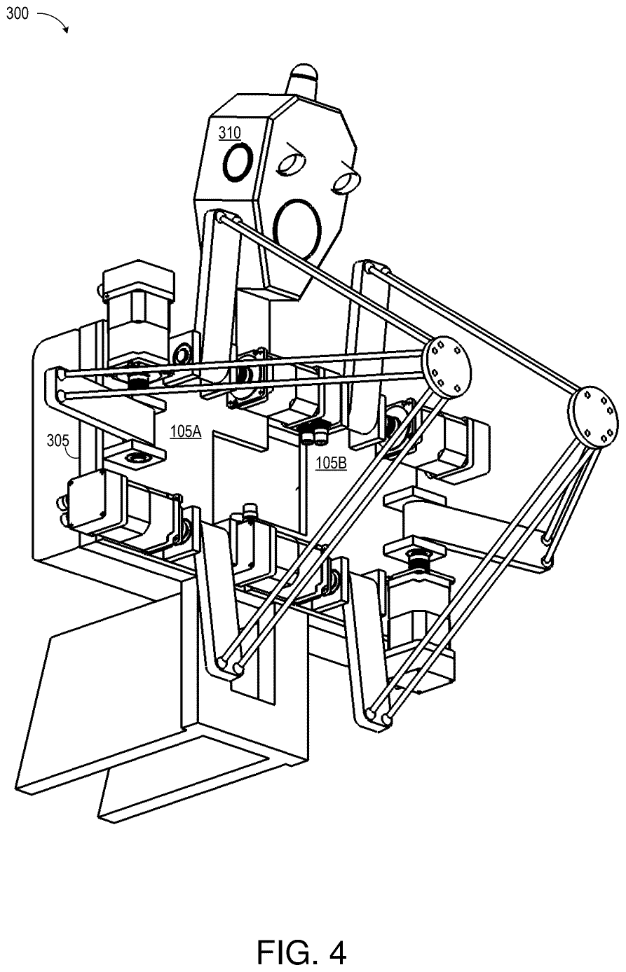

FIG. 4 is an oblique side view of robot 300 of FIG. 3 showing that frame 305 extends behind and supports vertical backplanes 105A and 105B.

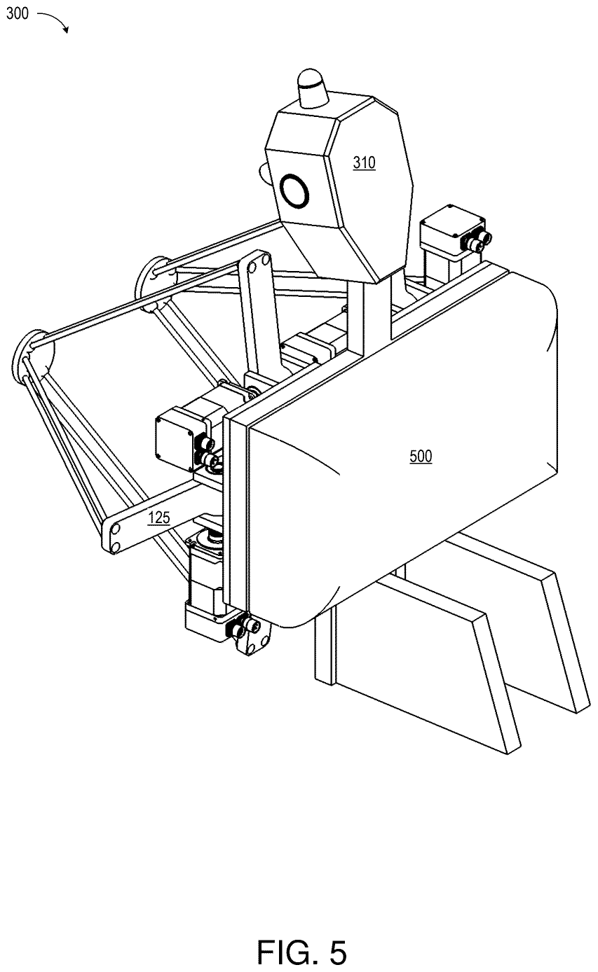

FIG. 5 is an oblique rear view of robot 300 of FIG. 3 with a housing 500 covering the back of robot 300. Housing 500 can include any drive electronics and control circuitry.

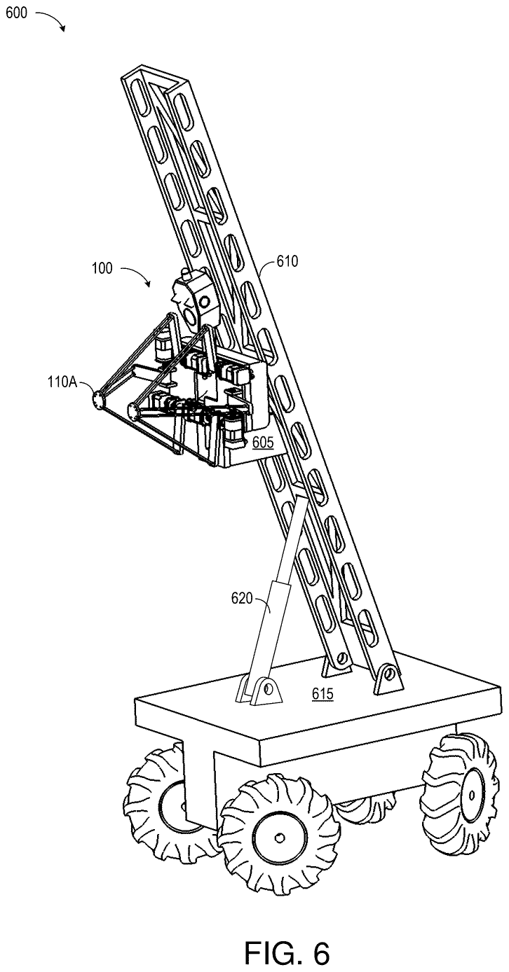

FIG. 6 depicts an autonomous or remote-controlled fruit-harvesting system 600 in which robot 100 of FIG. 1 is mounted on a slide 605 that moves up and down a guide rail 610 pivotally attached to a motorized, wheeled base 615. Guide rail 610 can be raised and lowered by an actuator 620 and, though not shown, can also be rotationally attached to base 615 so robot 100 can be redirected without moving the base. Additional end effectors 110 can be included on robot 100, and additional robots 110 can be included on the same or different guide rail on base 615. System 600 can position robot 100 within reach of fruit so end effectors 110A and 110B can work together to grasp and cut each fruit or can work independently for increased throughput.

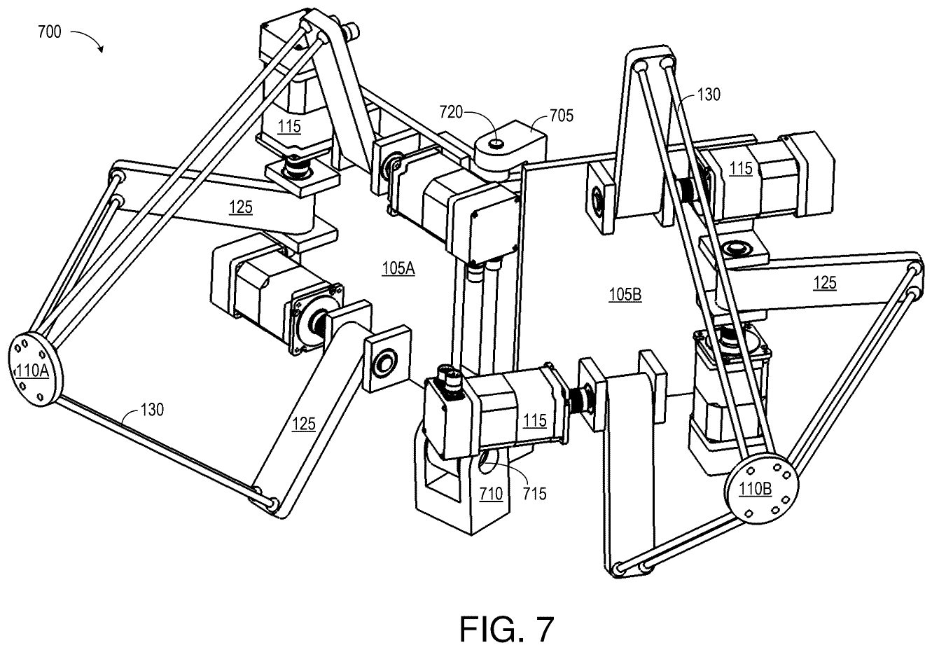

FIG. 7 is a front view of a split-backplane robot 700 in accordance with another embodiment. A hinge support 705 is pivotally connected to a mount 710 via a hinge 715 that can have discreet locking angles with or without actuation. Hinge support 705 supports hinges 720 that allow backplanes 105A and 105B to pivot relative to one another.

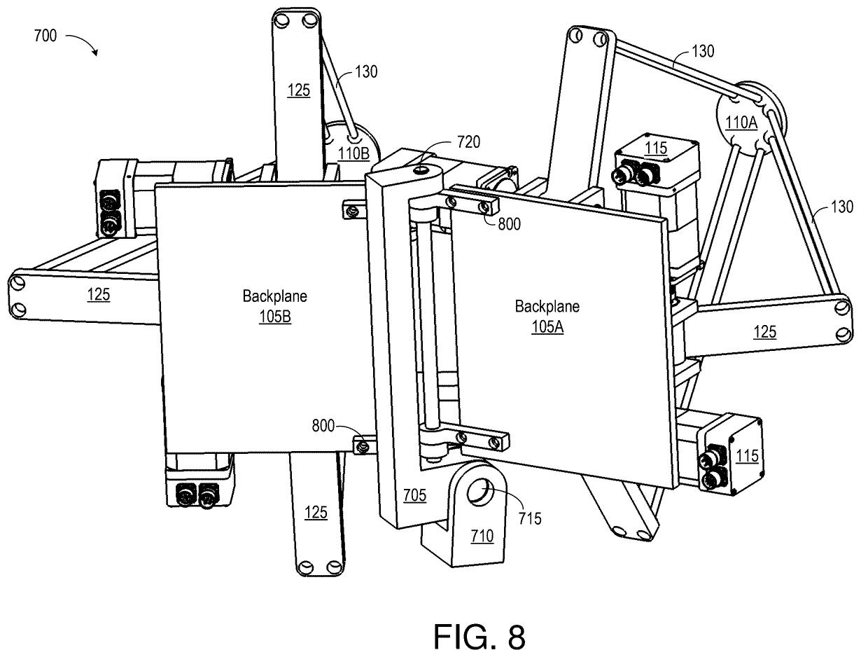

FIG. 8 is a back view of split-backplane robot 700 of FIG. 7 showing hinge support 705 and hinges 720 in more detail. Hinges 720 are pivotally connected along a common shaft with brackets 800 connected to each backplane 105A and 105B. Hinge 715 can have discreet locking angles with or without actuation. Actuators for actuating hinges 715 and 720 are omitted for ease of illustration; their placement and use will be readily apparent to those of skill in the art.

While the invention has been described with reference to specific embodiments thereof, it will be evident that various modifications and changes may be made thereto without departing from the broader spirit and scope of the invention. For example, robots can have more sets of arms and respective end effectors with ranges of motion that overlap one or more ranges of motion of the other sets of arms. features or aspects of any of the embodiments may be applied, at least where practicable, in combination with any other of the embodiments or in place of counterpart features or aspects thereof. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. A robot comprising:
a vertical backplane;
three actuators mounted to the vertical backplane, each actuator defining an axis of rotation; and
three arms each extending from a respective one of the actuators, each arm including:
a proximal link connected to the respective one of the actuators;
a distal link connected to the proximal link via a first rotary joint; and
an end effector connected to each of the distal links via a second rotary joint.

2. The robot of claim 1, wherein a first of the proximal links pivots in a first plane orthogonal to the vertical backplane and a pair of the proximal links pivots in a second plane orthogonal to both the first plane and the vertical backplane.

3. The robot of claim 1, wherein the end effector has exactly three pairs of rotary joints, one of the pairs for each of the three distal links.

4. The robot of claim 1, further comprising a backplane support connected to the backplane and a fourth actuator connected between the backplane support and the vertical backplane, the fourth actuator to move the vertical backplane relative to the backplane support.

5. A robot comprising:
a backplane;
six actuators mounted to the backplane, each actuator defining an axis of rotation; and
six arms each extending from a respective one of the actuators, each arm including:
a proximal link connected to the respective one of the actuators;
a distal link connected to the proximal link via a first rotary joint;
a first end effector connected to a first three of the distal links; and
a second end effector connected to a second three of the distal links.

6. The robot of claim 5, wherein a first pair of the proximal links pivots in a first plane orthogonal to the backplane, a second pair of the proximal links pivots in a second plane parallel to the first plane, and a third pair of the proximal links pivots in a third plane orthogonal to the first and second planes.

7. The robot of claim 6, wherein one of the proximal links of the third pair of the proximal links is of a link length and the first and second planes are separated by a spacing of less than the link length.

8. The robot of claim 5, wherein the backplane is vertical.

9. The robot of claim 5, the backplane comprising a first backplane section supporting the three of the arms connected to the first end effector and a second backplane section supporting the three of the arms connected to the second end effector.

10. The robot of claim 9, wherein the first backplane section is adjustable relative to the second backplane section.

11. The robot of claim 5, further comprising control circuitry connected to the six actuators to position the first and second end effectors relative to one another.

12. The robot of claim 5, further comprising:
a base connected to the backplane; and
a seventh actuator connected between the base and the backplane, the seventh actuator to move the backplane relative to the base.

13. The robot of claim 5, wherein the angular spacings between adjacent ones of the proximal links are uneven.

14. A robot comprising:
a backplane;
actuators mounted to the backplane, each actuator defining an axis of rotation; and
an arm extending from each of the actuators, each arm including:
a proximal link connected to the respective one of the actuators and operable in a proximal-link plane orthogonal to the backplane;
a distal link connected to the proximal link via a first rotary joint; and
an end effector connected to each of the distal links via a second rotary joint;
wherein the proximal-link planes intersect at a robot center; and
wherein the proximal-link planes have uneven angular spacings in a link-plane parallel to the backplane.

15. The robot of claim 14, wherein the uneven angular spacings include one angular spacing of at least 150 degrees.

16. The robot of claim 15, wherein the uneven angular spacings include one angular spacing of 180 degrees.

17. The robot of claim 15, wherein the proximal-link planes define three angular spacings.

18. The robot of claim 17, wherein the three angular spacings include two equal angular spacings.

19. The robot of claim 14, further comprising a second robot with second proximal links defining a second robot center.

20. The robot of claim 19, wherein the first-mentioned robot center is separated from the second robot center by a spacing of less than the sum of the length of one of the first-mentioned proximal links and the length of one of the second proximal links.
